(19) United States
(12) Patent Application Publication
(10) Pub. No.: US 2021/0048506 A1
(43) Pub. Date: Feb. 18, 2021

(54) METHODS AND SYSTEM FOR GENERATING AND DETECTING AT LEAST ONE DANGER ZONE

(71) Applicant: CAD.42 SERVICES, Paris (FR)

(72) Inventor: Jean-Philippe Panaget, Maisons-Laffitte (FR)

(73) Assignee: CAD.42 SERVICES, Paris (FR)

(21) Appl. No.: 16/968,939

(22) PCT Filed: Feb. 12, 2018
(86) PCT No.: PCT/FR2018/050333

§ 371 Date: Aug. 11, 2020

(51) Int. Cl. G01S 5/02; G01S 5/10; G08G 1/16

(52) U.S. Cl. CPC G01S 5/0284; G08G 1/166; G01S 5/10

(57) ABSTRACT

The invention mainly relates to a method for generating at least one spatial zone in a space, in particular a danger zone to be avoided, using at least one generating system comprising at least locating means and electronic management means, said generating method comprising at least one step (103) of determining, using the electronic management means, a contour of predetermined shape and dimensions defining the spatial zone using spatial coordinates from the generating system acquired by the locating means, and recording (104) the spatial coordinates defining said contour in a memory space of the electronic management means.

The invention falls within the field of obstacle detection and safety, and more precisely in the field of detection and avoidance of fixed or moving obstacles in a determined zone.

The invention more particularly aims to dynamically protect pedestrians or vehicles, whether they are moving or not, from at least one spatial zone to be avoided.

Document WO 201501094 discloses an anti-collision warning system intended to be worn by a user, this system comprising in particular a satellite geolocation system and communication means suitable both for transmitting position coordinates of the wearer and for receiving the position coordinates of a vehicle representing a mobile danger zone.

However, the warning system described in this document is of the passive type, since it does not make it possible to predict in advance the position of the vehicle representing this danger zone to be avoided, relative to the position of the pedestrian to be protected.

The invention thus aims to provide a method that makes it possible to overcome the drawbacks mentioned above, i.e. to provide a method that makes it possible to anticipate the position of at least one determined spatial zone, in particular a danger zone to be avoided, relative to the position of the person or element to be protected.

The invention also aims to provide a method for detecting such a spatial zone. Finally, the invention aims to provide a system suitable at least for implementing the above methods.

To this end, the method for generating at least one spatial zone in a space, in particular a danger zone to be avoided, using at least one generation system comprising at least locating means and electronic management means, which generation method comprises at least the successive steps of:
i. the electronic management means sending a command triggering the acquisition of the spatial coordinates of the generation system to the locating means;
ii. the electronic management means determining an outline of determined shape and dimensions delimiting the spatial zone on the basis of the spatial coordinates of the generation system acquired by the locating means, and recording the spatial coordinates defining said outline in a memory space of the electronic management means.

Thus, with the method of the invention, by ensuring the generation of spatial coordinates of danger zones to be avoided and by allowing these coordinates to be recorded in a system provided for this purpose, the position of these spatial zones to be avoided is known at all times. In fact, the system is always in anticipation of the position of at least one determined spatial zone.

The generation method of the invention may also include the following optional features considered in isolation or in any possible technical combination:

The method comprises an additional step iii during which the coordinates of the spatial zone are sent to at least one other generation system, via communication means integrated into each system.

The step i of sending the acquisition command is carried out manually by actuating a triggering member of push-button type that is integral with the generation system and electrically connected to the electronic management means.

The dimensions of the spatial zone, and the position of the spatial zone with respect to the position of the generation system acquired in step i, are automatically assigned to said spatial zone by the electronic management means during step ii, according to quantities recorded in the memory space of said electronic management means.

Step ii of determining an outline of the spatial zone comprises the successive sub-steps of:
a. periodically recording, in the memory space of the electronic management means, the position coordinates of the generation system as said generation system is moved in order to define the outline of the spatial zone;
b. once the outline of the spatial zone has been defined, the electronic management means sending a command terminating the acquisition of spatial coordinates in relation to the position of the system.

The sending of the termination-of-acquisition command during sub-step b is triggered by the release of the triggering member.

The space in which the spatial zone is defined is modeled by the electronic management means of the system in the form of a mesh.

The ratio of the distance separating the mesh nodes to the accuracy conferred by the locating means of the generation system is recorded in the memory space of the electronic management means, this ratio being between 1 and 3, and preferably being about 2.

Inside the spatial zone, the ratio is decreased by a factor recorded in the memory zone of the electronic management means, preferably by a factor of about \sqrt{2}.

The method comprises an additional step iv subsequent to the determination and recording step ii and consisting in detecting a spatial zone by means of the generation system capable of detecting such a spatial zone, this step iv comprising the successive sub-steps of:
a. the locating means periodically determining the position coordinates of the system, and the electronic management means periodically determining the distance between said position of the generation system and the spatial zone;
b. when the distance determined in the preceding sub-step is smaller than a predetermined distance recorded in the memory space of the management means, a warning device of the generation system issuing a warning signal.

The detected spatial zone being a mobile spatial zone, in particular a moving vehicle, characterized in that sub-step a of step iv comprises the electronic management means of the system periodically determining the spatial coordinates of the mobile zone in order to allow the electronic management means to periodically determine the distance between the generation system and the mobile zone 2 whose coordinates have been determined.

The electronic management means determine the possible trajectories of the generation system and/or of the mobile zone on the basis of their respective spatial coordinates, then determine a probability of collision between the generation system and the spatial zone.

The nature and/or intensity of the warning signal generated by the warning device depends on the probability of collision determined by the electronic management means and recorded in the memory space of the generation system.

The probability of collision is determined according to the successive sub-steps:
a. the electronic management means of the generation system determining the number of trajectories that may be taken by the generation and detection system;
b. the electronic management means determining the number of trajectories leading to a certain collision of the system with at least one spatial zone (2);
c. the electronic management means determining the number of dividing nodes N separating the generation and detection system from the trajectory closest to the system and leading to a certain collision, each dividing node representing T possible trajectories that may be taken from a trajectory that is upstream relative to the direction of movement of the system;
d. the electronic management means calculating the probability of collision according to the formula 1/T^{N}.

The warning signal generated by the warning device depends on a weighting index associated with the spatial zone detected by the system, this weighting index depending on the number of systems which have generated said spatial zone.

The invention also aims to provide a method for detecting at least one spatial zone, in particular a danger zone to be avoided, previously generated using at least one generation system which also forms a system for detecting such a zone, said system comprising at least locating means and electronic management means, which detection method comprises at least the successive steps of:
i. the locating means periodically determining the position coordinates of the detection system, and the electronic management means periodically determining the distance between said position of the system and the generated spatial zone;
ii. when the distance periodically determined in the preceding sub-step is smaller than a predetermined distance recorded in the memory space of the management means, a warning device of the detection system issuing a warning signal.

The detection method of the invention may also include the following optional features considered in isolation or in any possible technical combination:

The spatial zone is generated by the generation system implementing the generation method as described above.

The method comprises an additional step of detecting a mobile spatial zone, during which the spatial coordinates of the mobile zone are determined periodically by the electronic management means of the system, which management means periodically determine the distance between the position of the system and the mobile spatial zone whose coordinates have been determined.

The coordinates of the mobile zone are periodically determined according to the successive sub-steps of:
a. periodically receiving the spatial coordinates of the mobile zone by communication means included in the system;
b. periodically recording the spatial coordinates of the mobile zone in the memory space of the system.

The electronic management means determine the trajectory of the system and/or of the mobile zone on the basis of their respective spatial coordinates, then determine a probability of collision between the system and the spatial zone.

The warning signal generated by the warning device depends on the probability of collision determined by the electronic management means and recorded in the memory space of the system.

The probability of collision is determined according to the successive sub-steps:
a. the electronic management means of the generation system determining the number of trajectories that may be taken by the generation and detection system;
b. the electronic management means determining the number of trajectories leading to a certain collision of the system with at least one spatial zone;
c. the electronic management means determining the number of dividing nodes separating the generation and detection system from the trajectory closest to the system and leading to a certain collision, each dividing node representing T possible trajectories that may be taken from a trajectory that is upstream relative to the direction of movement of the system;
d. the electronic management means calculating the probability of collision according to the formula 1/T^{N}.

Each dividing node represents two possible downstream trajectories that may be taken from the upstream trajectory and in that the probability of collision is calculated according to the formula 1/2^{N}.

The warning signal generated by the warning device depends on a weighting index associated with the spatial zone detected by the system, this weighting index depending on the number of systems which have generated said spatial zone.

The invention also relates to a system for generating and detecting at least one spatial zone, in particular a danger zone to be avoided, suitable for implementing the generation method and the detection method as described above, characterized primarily in that it comprises:

electronic management means comprising a memory space,

a member for triggering the generation method as described above,

locating means for determining the coordinates of the system in real time,

communication means at least suitable for receiving, in real time, the spatial coordinates of a mobile spatial zone,

a warning device intended to generate a warning signal when the distance between the system and the spatial zone is smaller than a determined value recorded in the memory space and/or when the probability of collision between the system and the spatial zone is non-zero,

power supply means.

The generation and detection system may also include the following optional features considered in isolation or in any possible technical combination:

the generation and detection system is produced in the form of a safety vest.

The invention also relates to a set of two systems for generating and detecting at least one spatial zone as described above, characterized in that one of the systems, having generated a spatial zone by implementing the generation method as described above, is suitable for transmitting, via its communication means, the coordinates of the generated spatial zone to the communication means of the other system of the set.

The invention also relates to a computer program comprising instructions which, when the program is executed by computer, lead the latter to implement the steps of the generation method as described above and the steps of the detection method as described above.

The invention also relates to a computer-readable storage medium, on which the computer program as described above is recorded.

Other features and advantages of the invention will become clearly apparent from the description thereof that is provided below, by way of completely non-limiting indication, with reference to the appended figures, in which:

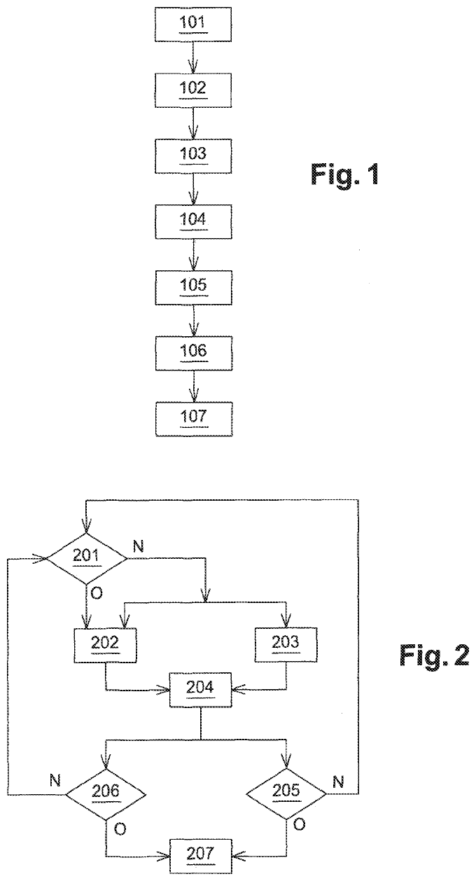

FIG. 1 is a diagram illustrating the main steps of the method for generating at east one spatial zone of the invention;

FIG. 2 is a diagram illustrating the main steps of the method for detecting at least one spatial zone of the invention;

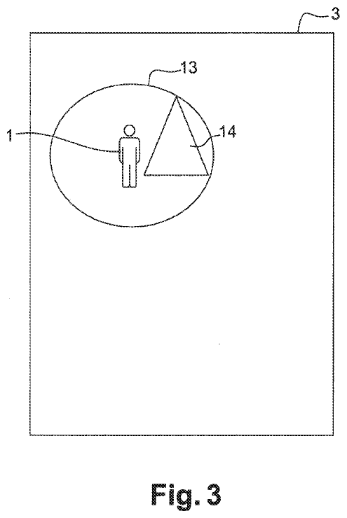

FIG. 3 illustrates a pedestrian wearing the generation system on the edge of a place deemed to be dangerous and for which a dangerous zone has been automatically generated by said system;

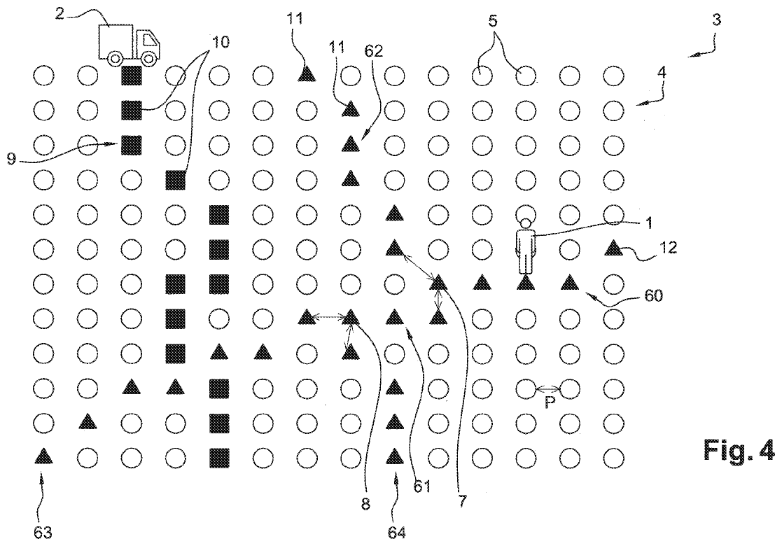

FIGS. 4 to 6 illustrate a two-dimensional space in the form of a mesh, and in which various probable trajectories of a pedestrian toward a spatial zone detected and/or generated by a generation and detection system according to the invention are respectively shown.

It is first of all specified that in the figures, the same references denote the same elements regardless of the figure in which they appear and regardless of the way in which these elements are represented. Likewise, if elements are not specifically referenced in one of the figures, their references may be easily found by referring to another figure.

It is also specified that the figures primarily represent one embodiment of the subject matter of the invention but that there may be other embodiments which meet the definition of the invention.

The present invention relates to a method that makes it possible to generate spatial zones within a delimited space 3 in which pedestrians 1 and motor vehicles 2 are liable to move. This space 3 is, for example and in a non-limiting manner, a construction site or an area in which work is taking place, and in which places or elements considered to be dangerous 14 must be avoided in particular by pedestrians 1 in order to avoid any accident. Such elements are for example moving vehicles 2 or lifting equipment, and such places are for example holes or trenches 14 made in the ground, or a fixed location where there is an electrical risk.

Thus, the generation method of the invention makes it possible to generate spatial zones 13 whose coordinates, for example geocentric coordinates in the frame of reference of the delimited space 3, correspond to the coordinates of the places or elements to be avoided. Thus, in the remainder of the description, the spatial zones 13 to be avoided and generated during the generation method of the invention will be called dangerous zones 13.

Furthermore, the detection method of the invention makes it possible, during its implementation, to detect at least one dangerous zone 13 to be avoided and previously generated for example during the implementation of the method for generating such zones, or by any other method able to generate a dangerous zone 13. This detection method is additionally capable of detecting any dangerous zone 2 which has not been previously generated, in particular a mobile dangerous zone 2, under conditions which will be discussed later in the description.

The delimited space 3 and the dangerous zones 2, 13 may be three-dimensional and defined according to geocentric coordinates in a three-dimensional frame of reference. By way of example, such a dangerous zone 2, 13 may be the danger cone generated by the movement of lifting equipment, such as a crane. Of course, this method is perfectly suited to a delimited space 3 and to two-dimensional dangerous zones. In the remainder of the description, and with reference to FIGS. 1 to 6, the two methods of the invention will be described for a delimited space 3 and two-dimensional dangerous zones 2, 13. The two-dimensional delimited space will be called, in the remainder of the description, work area 3.

The method for generating at least one dangerous zone 13 to be avoided, and the method for detecting such a zone 13, is implemented by a system for generating this zone 13, the features of which will now be described.

This system is preferably portable, for example to be easily put on board a vehicle. However, above all, this generation system is intended to be worn by a pedestrian 1 moving in the work area 3, with the aim of protecting them from these dangerous zones 2, 13 inherent to any construction site.

In a preferred embodiment, the generation system is a vest suitable for being worn by the pedestrian 1 (in particular a worker moving in the work area 3), and into which various devices are integrated allowing the implementation of the generation and detection methods of the invention, which will be explained below.

The generation system comprises electronic management means, typically comprising a circuit board provided with at least one processor and at least one memory space, for example and without limitation semiconductor-based rewritable mass storage. These electronic management means ensure the control and coordination of the other devices integrated into the generation system. The electronic management means make it possible in particular to control the implementation of the method for generating at least one dangerous zone 13.

The generation system comprises locating means, to make it possible to determine the position coordinates of the system at any time. For example, these locating means are a triangulation device of GPS (global positioning system) type or preferably an ultra-wideband positioning device, also referred to as a UWB locating device, which has the advantage of providing excellent location accuracy, typically about thirty centimeters. These two devices make it possible to determine the geocentric coordinates of the generation system at any time.

The generation system further comprises a triggering member connected to the circuit board, which is for example of the push-button type. This button allows the wearer of the generation system to initiate the implementation of the method for generating at least one dangerous zone 13, as will be described later.

The generation system also comprises communication means connected to the circuit board, for example a wireless transceiver device operating in a telecommunication network, allowing the generation system to communicate and exchange data with a remote server. The functions of these communication means will be described below in conjunction with the description of the method for generating the dangerous zone 13.

Finally, the generation system comprises means for supplying power to the other devices of said generation system, these power supply means being for example a rechargeable battery.

With reference to FIG. 1, the method for generating at least one dangerous zone 13 implemented by the generation system will now be described. To this end, a program recorded in the memory space of the circuit board of the generation system comprises instructions which, when the program is executed by the circuit board, lead said program to implement the steps of the generation method.

During the first step 101 of the generation method, which occurs when the wearer 1 of the generation system is positioned at the edge of a place that they deem to be dangerous 14, the wearer 1 actuates the triggering member, by pushing the push button. Pushing 101 this button has the direct consequence of the circuit board sending a command to the locating means triggering the acquisition of the geocentric coordinates of the generation system. These coordinates are then recorded 102 in the memory space of said circuit board.

The second step 103 of the method consists in determining an outline delimiting the dangerous zone 13, on the basis of the geocentric coordinates of the generation system determined in the first step. This second step 103 may be carried out according to two variants, depending on whether the wearer 1 releases the push button following a movement of the generation system or not.

In the first variant with reference to FIG. 3, the wearer 1 remains stationary and releases the push button. In this case, the circuit board of the generation system automatically assigns the dimensions and the position of the dangerous zone 13, in relation to the determined position of said generation system, according to quantities recorded in the memory space of the circuit board. By way of example, the circuit board will generate a dangerous zone 13 of circular shape of determined diameter, centered on the determined position of the generation system.

In the second variant, the wearer first maintains pressure on the push button, and moves 103 all around the edge of the place deemed to be dangerous 14. As the wearer 1 moves, the circuit board periodically determines and records 104 in its memory space the position coordinates of the moving system, on the basis of the information from the locating means.

Second, once the wearer has defined the outline of the location 14 deemed to be dangerous, they release 105 the push button. The circuit board then sends a command 106 terminating the periodic acquisition of the coordinates of the generation system.

Thus, the geocentric coordinates defining the outline of the place deemed to be dangerous 14, obtained according to the first or the second variant described above, then recorded 104 in the memory space of the circuit board of the generation system worn by the pedestrian 1, are assigned to this dangerous zone 13 by the circuit board. It is understood that the dangerous zones 13 thus generated are fixed zones.

Optionally, but preferably, and during the third step 107 of the generation method, the circuit board of the generation system sends 107, via the transceiver of the generation system, the geocentric coordinates defining the generated dangerous zone 13 to the remote server. These coordinates of the dangerous zone 13 are then recorded in a memory space of the server, for example a hard disk or any other known computer storage means.

This third step 107 is of particular importance when several pedestrians 1, each equipped with a generation system according to the invention, are moving in the work area 3. Indeed, each generation system may communicate via its transceiver with the server, and thus send or retrieve data thereto or therefrom. In particular, as soon as a dangerous zone 13 is generated by one of the generation systems present in the work area 3 and its coordinates recorded in the dedicated space of the server, all of the other generation systems retrieve the coordinates of this dangerous zone 13 via their transceiver.

Preferably, the system for generating a dangerous zone 13 also makes it possible to detect any dangerous zone 13 generated by said generation system or any other generation system present in the work area 3. This function of detecting a dangerous zone 13 is of course intended to protect the pedestrian 1 wearing the generation system and moving inside the work area 3. Since the generation system thus also forms a detection system, the generation system will be referred to in the remainder of the description as generation and detection system.

To optimize this protection, the generation and detection system also comprises a warning device, for example a sound and/or visual alarm, connected to the circuit board and suitable in particular for issuing a warning when a dangerous zone 13 is detected by the generation and detection system.

With reference to FIG. 2, a method for detecting a dangerous zone 2, 13 by the generation and detection system will now be described. It is understood that the wearer 1 of the system and/or the dangerous zone 2 is/are mobile and are therefore likely to encounter one another. The detection method aims to avoid this peril.

During the first step 201 of the detection method, the circuit board determines whether the dangerous zone is fixed 13 or mobile 2.

During the second step 202 of the detection method, the locating means controlled by the circuit board periodically determine the position of the generation and detection system.

In a first variant of this second step 202, when the dangerous zone 13 is fixed (i.e. the zone has been previously generated by a generation and detection system), the circuit board determines periodically, during a third step 204, the distance between the position of the generation and detection system determined in the second step and said dangerous zone 13.

In a second variant, when the dangerous zone 2 is mobile (i.e. the zone is represented by a moving vehicle 2), the generation and detection system must also periodically determine 203, during the second step, the geocentric coordinates of the mobile zone 2. To do this, the generation and detection system may comprise additional detection means, for example a device of radar type. Alternatively and preferably, the vehicle 2 comprises a locating means and a transceiver suitable for periodically transmitting its position. This item of data on the position of the vehicle 2 may then be intercepted by any generation and detection system located in the work area 3 via its transceiver, then recorded periodically in the memory space of the circuit board of the generation and detection system in question.

In a third step 205, when the distance between the dangerous zone 2, 13 and said generation and detection system becomes smaller than a determined value recorded in the memory space of the circuit board 205, the warning device then issues a signal 207 perceptible by the wearer 1. The wearer is thus warned that they are approaching a dangerous zone 2, 13, and that they must be particularly attentive to this risk of collision.

However, as long as the distance between the dangerous zone 2, 13 and said generation and detection system remains greater than the determined value, then the detection method of the invention resumes following the first step 201.

Particularly advantageously, the generation and detection system of the invention makes it possible to adapt the nature and/or the intensity of the warning signal according to the level of danger of the detected dangerous zone 2, 13 to be avoided. For example, the level of danger may refer to the probability of collision between the pedestrian 1 wearing the generation and detection system and the dangerous zone 2, 13, or may depend on a weighting index assigned to the dangerous zone 2, 13. These two particular cases will be described below.

The detection method of the invention therefore comprises additional steps that make it possible to evaluate the level of danger of the detected dangerous zone 2, 13 and, if applicable, the previously generated dangerous zone 13, in order to allow the circuit board of the generation and detection system in question to adapt the warning signal.

In the first particular case, a weighting index of the dangerous zone 13 generated by one of the generation and detection systems is assigned to this zone by the circuit board of the system in question, and recorded in the memory space of said circuit board. Thus, each time the coordinates of a generated dangerous zone 13 are sent to the other generation and detection systems, the weighting index assigned to the corresponding dangerous zone 13 is also sent.

If another generation and detection system subsequently generates a dangerous zone 13 whose outline intersects at least partly with an existing dangerous zone 13, then the weighting index associated with this dangerous zone 13 is iterated by a value determined by the circuit board of the generation systems present in the work area 3. For example, the weighting index of a dangerous zone 13 generated once is 1, the weighting index of a dangerous zone generated twice, by two different systems, is 2, and so on. In other words, the more often a dangerous zone 13 is generated by the generation and detection systems present in the work area, the higher its weighting index, and the higher the circuit board of the generation and detection system that detects such a zone 13 considers the level of danger of this dangerous zone 13 to be. The severity of the warning signal then issued 207 by the generation and detection system in question in the event of such a dangerous zone 13 being detected increases with increasing weighting index.

By way of example, if the warning signal is a sound signal, the sound intensity will increase with increasing weighting index. In the event of a visual warning signal, a color code may be established, varying from green to red depending on the weighting index. Of course, other types of warning signals varying according to the weighting index may be envisaged without departing from the scope of the invention.

Thus, in this first case of taking the level of danger into account, the triggering of the warning 207 by the circuit board is always dependent on the distance separating the dangerous zone 13 from the generation and detection system in question, but the nature and/or the intensity of the issued signal depends on the weighting index associated with the detected dangerous zone 13.

In the second particular case, the level of danger is directly linked to the probability of collision between the moving wearer 1 of a generation and detection system and a mobile 2 or fixed 13 dangerous zone.

To determine this probability, the circuit board of the generation and detection system in question uses the geocentric coordinates of said system and of the one or more dangerous zones 2, 13 that have already been periodically determined, to determine at least one possible trajectory 9, 60-64 of the system in question and/or of the mobile zone 2. Then, for each identified possible trajectory 60-64 of the wearer 1, the circuit board of the generation and detection system in question determines whether or not this trajectory 60-64 comes into collision with the mobile zone 2.

This therefore allows the circuit board to calculate, on the basis of all of the trajectories 9, 60-64 that can be taken by the wearer 1 and/or the mobile zone 2, the probability of collision between the wearer and the mobile dangerous zone 2. If the calculated probability 206 is zero, then the detection method of the invention resumes following the first step 201. If the calculated probability 206 is greater than 0, the circuit board will control the warning device so that the latter issues a warning signal 207. In addition, depending on the value of this probability, the circuit board will control the warning device so that the latter issues a signal corresponding to the calculated risk of collision. By way of example, if the warning signal is a sound signal, the sound intensity will increase with increasing probability of collision. In the event of a visual warning signal, a color code may be established, varying from green to red depending on the probability of collision. Of course, other types of warning signals varying according to the weighting index may be envisaged without departing from the scope of the invention.

The calculation of this probability of collision and the warning level resulting from this probability will now be illustrated through the three examples shown in FIGS. 4 to 6.

FIGS. 4 to 6 show a rectangular work area 3 for which a mesh 4 of determined pitch P has been produced. This mesh 4, the purpose of which is to optimize the evaluation of danger and in general the detection of a dangerous zone 2, 13, will be described in detail below. The points shown in these figures are therefore the nodes 5 of the mesh 4.

Furthermore, each of FIGS. 4 to 6 shows the trajectory 9 taken by a vehicle 2 (square-shaped points 10), such a vehicle 2 representing a mobile dangerous zone 2. In addition, the possible trajectories 60-64 of a pedestrian 1 wearing a generation and detection system are represented by triangles 11.

The pedestrian 1 who is moving in the work area 3 may take three different trajectories 62, 63, 64. From their starting point 12 (located to the right of FIGS. 4 to 6), and moving toward the dangerous zone 2 (i.e. to the left of FIGS. 4-6), a main path 60 taken by the pedestrian 1 is divided a first time into first 61 and second 62 branches at a first dividing node 7. Next, the first 61 of the two branches is itself divided into first 63 and second 64 sub-branches at a second dividing node 8. Only the first 63 of the sub-branches comes into collision with the trajectory 9 of the vehicle 2 representing the mobile danger zone 2.

All of this information is recorded in the memory space of the circuit board of the system worn by the pedestrian 1, and this circuit board determines the probability of collision according to the number of dividing nodes 7, 8 separating the pedestrian 1 from the sub-branch 63 which crosses the path 9 of the vehicle 2, namely the first sub-branch 63.

In FIG. 4, the pedestrian 1 is located on the main path 60 between their starting point 12 and the first dividing node 7. The circuit board of the generation and detection system worn by the pedestrian 1, using the data relating to the three trajectories 62, 63, 64, to the dividing nodes 7, 8 and to the existence of a collision between the first sub-branch 63 and the trajectory 9 of the vehicle 2, therefore identifies the presence of two dividing nodes 7, 8 between the generation and detection system and the first sub-branch 63, The pedestrian 1 has a one-in-two chance of taking the first branch 61, then a one-in-two chance of next taking the first sub-branch 63. The probability of collision for the pedestrian 1 in FIG. 3 calculated by the circuit board is therefore 25%. The circuit board orders the issuing of an unsevere warning signal, for example just a light signal.

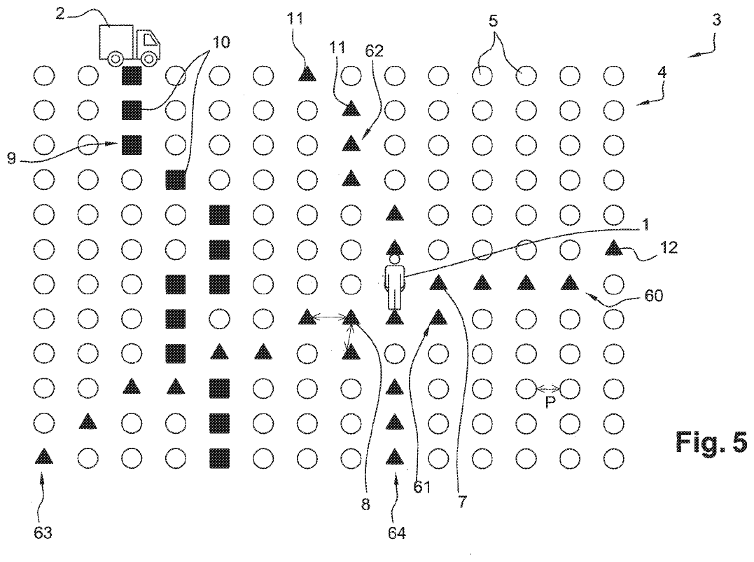

In FIG. 5, the pedestrian 1 has already taken the first branch 61 and is therefore located between the first dividing node 7 and the second dividing node 8. The circuit board of the generation and detection system worn by the pedestrian therefore identifies the presence of a single dividing node 8 between the generation and detection system and the first sub-branch 63. The pedestrian 1 has a one-in-two chance of taking the first sub-branch 63. The probability of collision for the pedestrian 1 in FIG. 3 calculated by the circuit board is therefore 50%. The circuit board orders the issuing of a moderately severe warning signal, for example a light signal coupled with a sound signal.

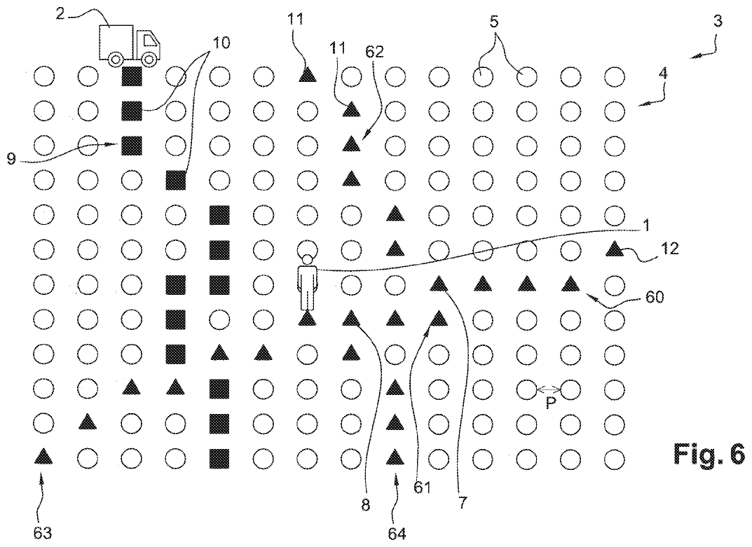

In FIG. 6, the pedestrian 1 has taken the first sub-branch 63. If they continue on their way, the probability of collision with the vehicle 2 is therefore 100%, because there is no longer any chance of the pedestrian 1 changing direction. The circuit board orders the issuing of a severe warning signal, for example a light signal coupled with a sound signal and with a message specifying the nature of the danger, displayed on a display means of the generation and detection system connected to the circuit board. Such a signal should cause the pedestrian 1 to stop.

These three examples can of course be generalized to as many dividing nodes as possible, knowing that downstream of each dividing node, a number T of possible directions are considered for the pedestrian (the term downstream being understood in relation to the direction of movement of the pedestrian 1). To determine a probability of collision, the circuit board of the detection system worn by the pedestrian 1 determines the number N of dividing nodes that exist between the position of the detection system and the trajectory leading to a certain collision with a dangerous zone 2, 13. The probability of collision determined by the circuit board of the detection system in question is then 1/T^{N}. In a simplified manner, by considering only two possible directions downstream of each dividing node, the probability of collision determined by the circuit board of the detection system in question will then be 1/2^{N}.

Thus, in the second particular case of taking the level of danger into account, the triggering 207 of the warning by the circuit board is independent of the distance separating the dangerous zone 2, 13 from the generation and detection system, and the warning may be triggered as soon as a probability of collision exists 206, even if the generation and detection system is still relatively far away from the dangerous zone 2, 13. The nature and/or intensity of the issued signal depends this time on the probability of collision.

It should be understood that the two particular cases described above are not exclusive, and may be implemented by the same generation and detection system during the detection method of the invention, at the same time or alternately. It is even more advantageous to combine these two particular cases so as to ensure optimum safety for the wearer 1. For example, a detected probability of collision coupled with a high weighting index for the dangerous zone 13 in question will lead to the generation and detection system in question issuing a particularly severe warning signal, even if the probability of collision is not particularly high.

With reference to FIGS. 4 to 6, and to optimize the evaluation of danger and in general the detection of a dangerous zone 2, 13, the circuit boards of the generation and detection systems present in the work area 3 each comprise in their memory space a mesh 4 of said work area 3. This mesh 4 is produced beforehand, either by the circuit board directly, or by any computer system, in which case the mesh 4 is subsequently sent and recorded in the memory space of the circuit board of the generation and detection system in question.

The mesh 4 comprises a plurality of regularly spaced nodes 5, and the pitch of the mesh P (i.e. the distance separating two adjacent nodes 5) depends directly on the accuracy conferred by the locating means of the generation and detection system. Preferably, the ratio of the pitch of the mesh P to the accuracy of the locating means is between 1 and 3, and is more preferably about 2. Thus, when the locating system is a UWB locating device, the accuracy of which is about thirty centimeters, the pitch of the mesh P is about sixty centimeters. This ratio is recorded in the memory space of the circuit board of the generation and detection system in question.

Advantageously, as soon as a dangerous zone 13 is generated, each generation and detection system that is present in the work area 3 and has received the coordinates of this generated dangerous zone 13 calculates a new mesh pitch P for the portion of the work area located inside said generated dangerous zone 13. This new pitch P is smaller, which increases the definition of the mesh 4 in the generated dangerous zone 13 and therefore the accuracy of the future detection. Preferably, the new ratio of the new pitch of the mesh P inside the generated dangerous zone 13 to the accuracy of the locating system is about \sqrt{2}. Of course, this new mesh pitch P applies to all of the dangerous zones 13 generated inside the work area 3.

The embodiment described above is in no way limiting, and modifications may be made thereto without departing from the scope of the invention. For example, the steps described above of the detection method may form an integral part of the generation method of the invention, and be implemented after the second or third step of said generation method.

1. A method for generating at least one spatial zone in a space, using at least one generation system comprising at least locating means and electronic management means, wherein the generation method comprises, successively:
by the electronic management means, sending a command triggering acquisition of spatial coordinates of the generation system to the locating means; then,
by the electronic management means, determining an outline of determined shape and dimensions delimiting the spatial zone on the basis of the spatial coordinates of the generation system acquired by the locating means, and recording the spatial coordinates defining the outline in a memory space of the electronic management means.

2. The generation method as claimed in claim 1, further comprising sending the coordinates of the spatial zone to at least one other generation system, via communication means integrated into each of the two systems.

3. The generation method as claimed in claim 1, wherein the sending of the acquisition command is carried out manually by actuating triggering member of push-button type that is integral with the generation system and electrically connected to the electronic management means.

4. The generation method as claimed in claim 1, wherein dimensions of the spatial zone, and a position of the spatial zone with respect to a position of the generation system acquired by acquisition of the spatial coordinates of the generation system triggered by the command sent by the electronic management means to the locating means, are automatically assigned to the spatial zone by the electronic management means during the determining of the outline of determined shape and dimensions delimiting the spatial zone and recording of the spatial coordinates defining the outline in the memory space of the electronic management means, according to quantities recorded in the memory space of the electronic management means.

5. The generation method as claimed in claim 1, wherein the determining of the outline of the spatial zone comprises, successively:
periodically recording, in the memory space of the electronic management means, the position coordinates of the generation system as the generation system is moved in order to define the outline of the spatial zone; then,
once the outline of the spatial zone has been defined, sending, by the electronic management means, a command terminating the acquisition of spatial coordinates in relation to the position of the system.

6. The generation method as claimed in claim 5, wherein the sending of the termination-of-acquisition command during the sending of the command terminating the acquisition of spatial coordinates is triggered by a release of the triggering member.

7. The generation method as claimed in claim 1, wherein the space in which the spatial zone is defined is modeled by the electronic management means of the system in the form of a mesh.

8. The generation method as claimed in claim 7, wherein a ratio of a distance separating nodes of the mesh to an accuracy conferred by the locating means of the generation system is recorded in the memory space of the electronic management means, the ratio being in a range of from 1 to 3.

9. The generation method as claimed in claim 7, wherein inside the spatial zone, the ratio is decreased by a factor recorded in the memory zone of the electronic management means.

10. The generation method as claimed in claim 1, further comprising, subsequent to the determination and recording, detecting a spatial zone, by the generation system, the detecting comprising, successively:
by the locating means, periodically determining the position coordinates of the system, and by the electronic management means, periodically determining the distance between the position of the generation system and the spatial zone; then,
by a warning device of the generation system, when the distance, determined in the periodical determining of the position coordinates of the system and of the distance between the position of the generation system and the spatial zone, is smaller than a predetermined distance recorded in the memory space of the management means, issuing a warning signal.

11. The generation method as claimed in claim 10, the detected spatial zone being a mobile spatial zone, wherein the detecting comprises:
by the electronic management means of the system, periodically determining the spatial coordinates of the mobile zone in order to allow the electronic management means to periodically determine the distance between the generation system and the mobile zone whose coordinates have been determined.

12. The generation method as claimed in claim 10, wherein the electronic management means determine possible trajectories of at least one selected from the the group consisting of the generation system and the mobile zone on the basis of respective spatial coordinates thereof, then determine a probability of collision between the generation system and the spatial zone.

13. The generation method as claimed in claim 12, wherein at least one selected from the group consisting of a nature and an intensity of the warning signal generated by the warning device depends on the probability of collision determined by the electronic management means and recorded in the memory space of the generation system.

14. The generation method as claimed in claim 12, wherein the determining of the probability of collision comprises, successively:
by the electronic management means of the generation system, determining a number of trajectories that may be taken by the generation and detection system;
by the electronic management means, determining the a number of trajectories leading to a certain collision of the system with at least one spatial zone;
the electronic management means, determining a number of dividing nodes N separating the generation and detection system from the trajectory closest to the system and leading to a certain collision, each dividing node representing T possible trajectories that may be taken from a trajectory that is upstream relative to a direction of movement of the system; then,
by the electronic management means, calculating the probability of collision according to the formula 1/T^{N}.

15. The generation method as claimed in claim 1, wherein the warning signal generated by the warning device depends on a weighting index associated with the spatial zone by the system, the weighting index depending on the number of systems which have generated the spatial zone.

16. A method for detecting at least one spatial zone, previously generated using at least one generation system which also forms a system for detecting such a zone, the system comprising at least locating means and electronic management means, wherein the detection method comprises at least, successively:
by the locating means, periodically determining, position coordinates of the detection system, and periodically determining the distance between the position of the system and the generated spatial zone; then,
by a warning device of the detection system, when the distance periodically determined in the preceding sub-step is smaller than a predetermined distance recorded in a memory space of the management means, issuing a warning signal.

17. The detection method as claimed in claim 16, wherein the spatial zone is generated by the generation system implementing a generation method comprising:
by the electronic management means, sending a command triggering acquisition of spatial coordinates of the generation system to the locating means; then,
by the electronic management means, determining an outline of determined shape and dimensions delimiting the spatial zone on the basis of the spatial coordinates of the generation system acquired by the locating means, and recording the spatial coordinates defining the outline in a memory space of the electronic management means.

18. The detection method as claimed in claim 16, further comprising:
detecting a mobile spatial zone, comprising, by the electronic management means of the system, determining periodically spatial coordinates of the mobile zone and periodically a distance determining between the position of the system and the mobile spatial zone whose coordinates have been determined.

19. The detection method as claimed in claim 18, wherein the periodical determining of the coordinates of the mobile zone comprises, successively:
periodically receiving the spatial coordinates of the mobile zone by communication means included in the system; then,
periodically recording the spatial coordinates of the mobile zone in the memory space of the system.

20. The detection method as claimed in claim 16, wherein the electronic management means determine the trajectory of at least one selected from the group consisting of the system and the mobile zone on the basis of respective spatial coordinates thereof, then determine a probability of collision between the system and the spatial zone.

21. The detection method as claimed in claim 20, wherein the warning signal generated by the warning device depends on the probability of collision determined by the electronic management means and recorded in the memory space of the system.

22. The detection method as claimed in claim 20, wherein the determining of the probability of collision is determined comprises, successively:
by the electronic management means of the generation system, determining a number of trajectories that may be taken by the generation and detection system;
by the electronic management means, determining a number of trajectories leading to a certain collision of the system with at least one spatial zone;
by the electronic management means, determining a number of dividing nodes separating the generation and detection system from the trajectory closest to the system and leading to a certain collision, each dividing node representing T possible trajectories that may be taken from a trajectory that is upstream relative to a direction of movement of the system; then,
by the electronic management means, calculating the probability of collision according to the formula 1/T^{N}.

23. The detection method as claimed in claim 22, wherein each dividing node represents two possible downstream trajectories that may be taken from the upstream trajectory, and wherein the probability of collision is calculated according to the formula 1/2^{N}.

24. The detection method as claimed in claim 16, wherein the warning signal generated by the warning device depends on a weighting index associated with the spatial zone detected by the system, the weighting index depending on a number of systems which have generated the spatial zone.

25. A system for generating and detecting at least one spatial zone, the system comprising:
electronic management means comprising a memory space,
a member for triggering the generation method as claimed in claim 1,
locating means for determining the coordinates of the system in real time,
communication means at least suitable for receiving, in real time, spatial coordinates of a mobile spatial zone,
a warning device, and
power supply means,
wherein the warning device is adapted to generate a warning signal when at least one of the following conditions is met:
a distance between the system and the spatial zone is smaller than a determined value recorded in the memory space,
the probability of collision between the system and the spatial zone is non-zero.

26. The system as claimed in claim 25, characterized in that it is produced in the form of a safety vest.

27. A set of two systems for generating and detecting at least one spatial zone, wherein each of the two systems of the set is a system as claimed in claim 25, wherein one of the systems of the set, having generated a spatial zone, is adapted for transmitting, via its communication means, the coordinates of the generated spatial zone to the communication means of the other system of the set.

28. A non-transitory storage medium on which a computer program is recorded, wherein the computer program comprises instructions which, when the program is executed by computer, causes the computer to implement the generation method as claimed in claim 1.

29. A non-transitory computer-readable storage medium on which a computer program is recorded, wherein the computer program comprises instructions which, when the program is executed by computer, causes the computer to implement the detection method as claimed in claim 16.
